(19) United States
(12) Patent Application Publication
(10) Pub. No.: US 2010/0319479 A1
(43) Pub. Date: Dec. 23, 2010

(54) SURFACE MOUNT ROTARY CONTROL

(75) Inventors: Donald E. Sjolin, Granger, IN (US); Eric Nathaniel Combs, Goshen, IN (US); Todd Brian Lozier, Elkhart, IN (US); John E. McLoughlin, Hauppauge, NY (US); Neocles G. Athanasiades, Setauket, NY (US); Toh K. Meng, Hauppauge, NY (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: ELKHART BRASS MANUFACTURING COMPANY, INC., Elkhart, IN (US)

(21) Appl. No.: 12/793,109

(22) Filed: Jun. 3, 2010

Related U.S. Application Data
(60) Provisional application No. 61/218,669, filed on Jun. 19, 2009.

(51) Int. Cl. G05G 1/10

(52) U.S. Cl. 74/504

(57) ABSTRACT

A rotary control for controlling an electromechanical device includes a body adapted to mount to a surface and an outer ring pivotally connected to the body. The outer ring has an outer perimeter with a generally undulating profile having peaks and valleys, and has an outer face with a plurality of protrusions extending from the outer face, with the protrusions substantially corresponding with the peaks. The rotary control also includes a sensor adapted to sense rotation of the outer ring and output a signal corresponding to the rotation, and a control adapted to receive the signal and control the electromechanical device in response to the rotation of the outer ring.

### CROSS-REFERENCES TO RELATED APPLICATION

This application claims priority from U.S. Pat. application Ser. 61/218,669, filed Jun. 19, 2009, entitled SURFACE MOUNT ROTARY CONTROL, which is incorporated by reference herein in its entirety.

### TECHNICAL FIELD AND BACKGROUND OF THE INVENTION

The present invention relates generally to operator interfaces and, more specifically, to rotary controls. Further, the present invention is particularly useful in a fire fighting environment where operators typically wear gloves.

### SUMMARY OF THE INVENTION

Accordingly, the present invention provides a surface mount rotary control which is adapted for use by an operator wearing gloves, such as a fire fighter, to provide enhanced control of an electromechanical device, such as a valve or motor, even under adverse conditions. The rotary control includes an outer ring with grippable surface and a ratcheting mechanism that allows for fine adjustments even with limited tactile control. Further, the rotary control may also incorporate one or more display devices that provide the user with visual feedback information from electromechanical devices operated by the rotary control.

In one form of the invention, a rotary control for controlling an electromechanical device includes a base, which is adapted to mount to a surface, and an outer ring rotatably connected to the base. The outer ring has an outer perimeter with a profile having a generally undulating shape that includes peaks and valleys. The outer ring also has an outer face with a plurality of protrusions extending from the outer face whose location on the outer face substantially corresponds with the location of the peaks on the perimeter. The rotary control also includes a sensor for sensing rotation of the outer ring and a control in communication with the sensor. The sensor outputs a signal corresponding to the rotation of the outer ring with the control controlling the electromechanical device in response to the signals from the sensor and in turn the rotation of the outer ring.

In one aspect, the rotary control further includes a connecting ring positioned between the base and the outer ring. The outer ring is adapted to releasably mount to the connecting ring, for example by a snap fit connection, and further is frictionally coupled to the connecting ring to thereby rotate with the connecting ring, which rotatably mounts the outer ring to the base. Thus, the outer ring may be removable from the connecting ring for repair or replacement.

In a further aspect, the base includes an undulating portion substantially about the full perimeter of the base, which is adapted to interact with the connecting ring. The connecting ring includes a central axis and a perimeter portion and further includes at least one detent mechanism located at the perimeter portion that protrudes out of the connecting ring in the direction of the central axis. The detent mechanism cooperates with the undulating portion to define a ratcheting mechanism. Accordingly, as the outer ring is rotated the ratcheting mechanism may provide tactile and/or audible feedback as the detent mechanism traverses from peak to valley on the undulating portion. For example, the connecting ring may include two ratcheting mechanisms, which may be located at mutually opposed positions on the perimeter portion with respect to the central axis. Further, the detent mechanism includes a biasing element, for example a coil spring, whose spring resistance may be varied to adjust the desired tactile or audible effect. Similarly, the depth of the undulations may also be varied to change the tactile feel of the interaction as the detent mechanism is moved over the undulations, or the audible sound, such as a “click”.

In another aspect, the base and connecting ring may form a raceway for holding a plurality of bearings, which retain the connecting ring on the base and facilitated rotation of the connecting ring and outer ring about the base.

In a further aspect of the rotary control, the base further includes a mounting flange adapted to mount the base on a panel or other planar surface. The mounting flange may have a plurality of apertures adapted to receive bolts or other fasteners. Alternatively, the mounting flange may be adapted for use with an adhesive or may include a feature adapted to mesh or lock with a corresponding feature on a panel or planar surface.

In yet another aspect of the base, the base may include an outer face having one or more displays. The displays may include a series of light emitting diodes arranged, for example, along an arcuate path for providing a visual indicator of the position of the outer ring and also of the position of a component of the electromechanical device being controlled by the control. For example, as the outer ring is rotated clockwise, the light emitting diodes may illuminate in sequence along the arcuate path in a clockwise direction. The outer face may also include one or more liquid crystal displays. For example, the outer face may include a liquid crystal display for displaying a fluid pressure, and may include another liquid crystal display for displaying a fluid flow rate. Additionally, the outer face may include one or more buttons. For example, the outer face may include a central button for establishing a preset condition of the rotary control.

In yet another aspect of the rotary control, the control may be responsive to at least one sensor adapted to sense the rotation of the outer ring. The sensor may be an inductive sensor located in the control and adapted to read magnetic or steel projections formed on or applied to the connecting ring. Alternatively, the sensor may be other non-contact sensors, such as an optical sensor or a magnetic hall sensor or the like.

In another aspect, the outer ring may be made from an elastomeric or other flexible material. The flexible material may have a high coefficient of friction, for example a rubber or material with rubber characteristics, and a moderate rigidity to facilitate a firm grip even by gloved hands or in wet conditions.

In another form of the invention, a rotary control for controlling an electromechanical device includes a base with a cylindrical wall with an annular raceway and an outer periphery with an external annular groove. The cylindrical wall includes an undulating portion that forms a plurality of peaks and valleys. Mounted to the cylindrical wall is an annular member, which includes an undulating outer perimeter and a detent mechanism for engaging and following the undulating portion of the cylindrical wall of the base to thereby provide a gripping surface and a tactile or audible feedback to a user rotating the annular member about the base.

In another aspect, the detent mechanism includes a ball and spring supported for rotational movement with the annular member. The spring biases the ball into engagement with the undulating portion of the base.

In a further aspect, the annular member is mounted to the base by another inner annular member, which forms a connecting ring. The connecting ring is mounted on the base. The connecting ring further includes an internal annular groove adapted to cooperate with the external annular groove formed on the cylindrical wall of the base to form a raceway for holding a plurality of bearings, such as ball bearings, which facilitate rotation of the two annular members about the base and further rotatably couple the inner annular member to the base.

According to yet another aspect, the control includes a sensor, such as a non-contact sensor, adapted to sense rotation of the outer ring and to output a signal corresponding to the rotation, as well as a microprocessor-based control adapted to receive the signal and control the electromechanical device in response to the rotation of the outer ring.

Accordingly, the present invention provides a rotary control that can be user by a gloved hand and provides tactile and/or audible and/or visual feedback the user.

These and other objects, advantages, purposes and features of the present invention will become apparent upon review of the following specification in conjunction with the drawings.

### BRIEF DESCRIPTION OF THE DRAWINGS

FIG. 1 is a perspective view of a surface mount rotary control illustrating a first embodiment of the present invention;

FIG. 2 is a side elevation of the rotary control of FIG. 1;

FIG. 3 is a cross-section taken along line of FIG. 2;

FIG. 3a is an enlarged view of a portion of the rotary control of FIG. 3, illustrating a detent mechanism;

FIG. 4 is a front elevation of the surface mount rotary control of FIG. 1;

FIG. 5 is a cross-section view taken through line V-V of FIG. 4;

FIG. 5a is an enlarged view of a portion of the cross-section view of FIG. 5, illustrating a bearing element and position sensor;

FIG. 6 is an exploded perspective view of the rotary control of FIG. 1;

FIG. 7 is a back elevation of the outer ring of FIG. 6;

FIG. 8 is a front elevation view of the outer ring;

FIG. 9 is a cross-section view taken along line IX-IX of FIG. 8;

FIG. 10 is a back elevation of the connecting ring of FIG. 6;

FIG. 11 is a front elevation view of the connecting ring;

FIG. 12 is a cross-section view taken along line XII-XII of FIG. 11;

FIG. 13 is a front elevation view of the base of FIG. 6;

FIG. 14 is a side elevation view of the base of FIG. 13 viewed from the side;

FIG. 15 is a section view taken along line XV-XV of FIG. 14 illustrating the undulating surface profile;

FIG. 16 is a section view taken along line XVI-XVI of FIG. 13 viewed from the bottom;

FIG. 17 is a schematic illustrating electrical connections between a rotary control and a valve;

FIG. 18 is a perspective view of another embodiment of a surface mount rotary control of the present invention;

FIG. 19 is yet another embodiment of a surface mount rotary control of the present invention configured as a handheld device; and

FIG. 20 is a front elevation view of the surface mount rotary control of FIG. 19.

### DESCRIPTION OF THE PREFERRED EMBODIMENTS

Referring now to the drawings and the specific embodiments depicted therein, the numeral 10 generally designates a surface mount rotary control for controlling a mechanical device, such as a valve, pump, motor or the like. As will be more fully described below, surface mount rotary control 10 is configured to facilitate manipulation by a user wearing gloves and still provide tactile or audible or visual feedback when adjusting the control.

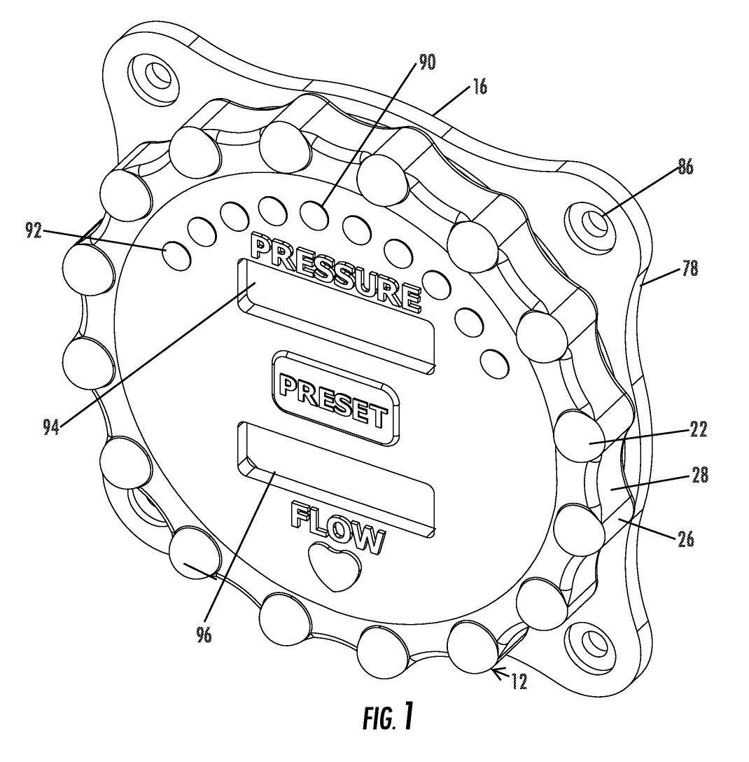

Referring now to FIGS. 1-6, rotary control 10 includes outer annular member or ring 12, which forms a control knob, an intermediate or connecting annular member or ring 14, and a base 16. As will be described in detail below, outer ring 12 is rotatably coupled to connecting ring 14 so that they rotate in unison about base 16 but releasably coupled so that outer ring 12 may be removed from ring 14 for repair or replacement. Alternately, outer ring 12 and connecting ring 14 may be formed as a single ring, such as described in reference to the second embodiment.

Connecting ring 14 is adapted to interact with a microprocessor-based controls housed in or adjacent to base 16 so that when rotated about base 16, connecting ring 14 will vary the input to the microprocessor-based controls, described more fully below. To provide user-perceptible tactile feedback to the user, when rotated connecting ring 14 encounters fixed periods of high resistance and low resistance to rotation throughout its range of motion. This may provide a tactile feedback and/or an audible feedback. In addition, visual feedback indicators may be mounted to base 16, as will also be described in detail below.

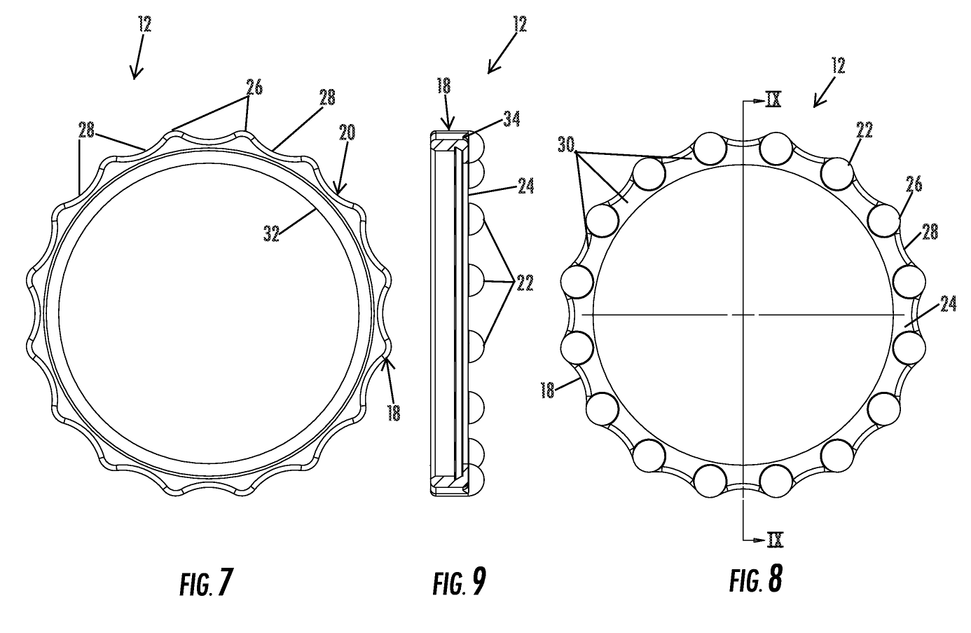

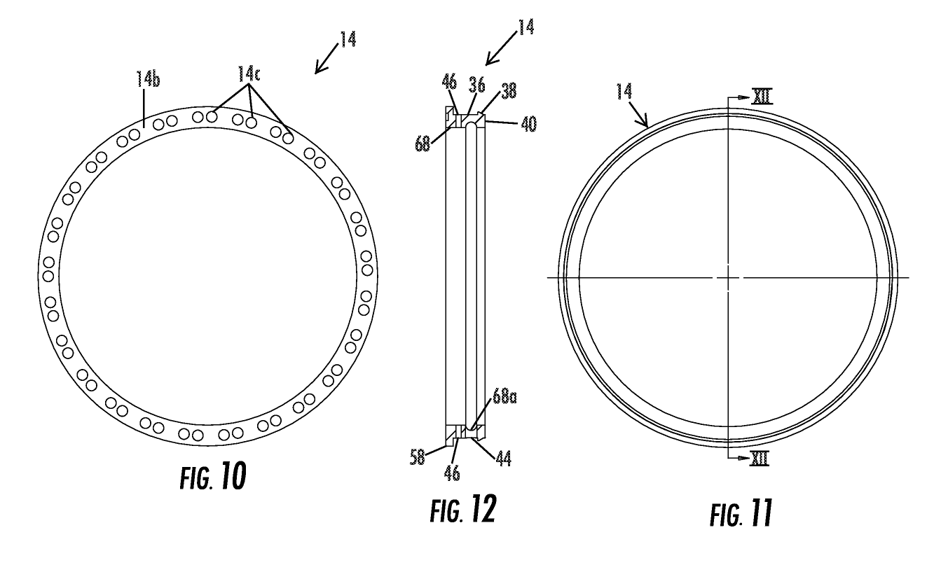

Referring now to FIGS. 7-9, outer ring 12, which provides the user-interface portion of rotary control 10, includes an outer perimeter 18 with an undulating profile 20 (FIG. 7) and a plurality of cylindrical shaped protrusions 22 extending laterally from an outer face 24 of outer ring 12. Further, outer perimeter 18 of ring 12 follows a generally arcuate closed path with a circumference sufficient to be grasped easily and firmly by a gloved hand. Undulating profile 20 forms peaks 26 and valleys 28, which are adapted to provide a surface on outer perimeter 18, which are sized and shaped to be easily grasped by gloved fingers. Protrusions 22 project from outer face 24 and are spaced to form gaps 30 which may provide sufficient space between adjacent protrusions 22 to allow a gloved finger to rest in gaps 30 (FIG. 9). Moreover, outer perimeter 18, undulating profile 20 and protrusions 22, taken together, facilitate manual control of outer ring 12 when a user grasps outer ring 12 about outer perimeter 18 from the direction of outer face 24. Though it should be understood that any one of these features improves manual control of ring 12. Additionally, outer ring 12 may be made from a high friction material, such as an elastomer material for added grip, tactile response, and color coding of multiple outer rings 12 on a panel.

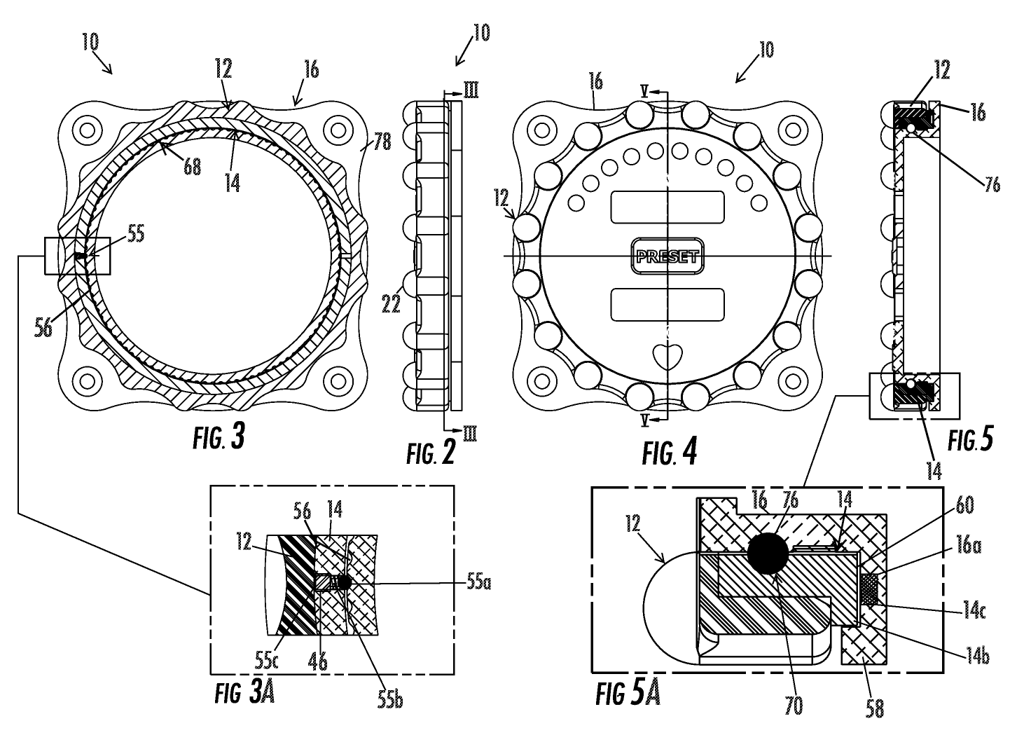

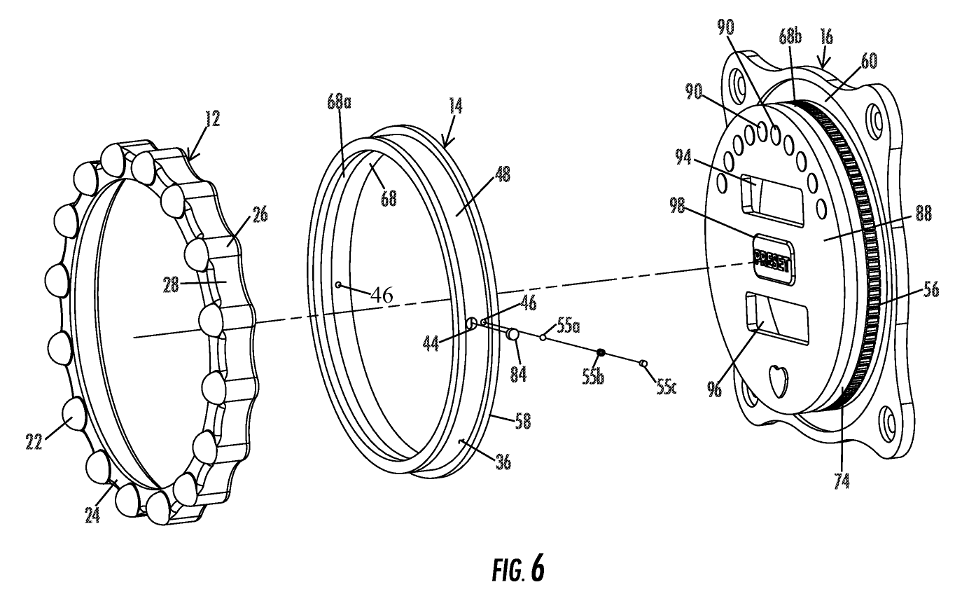

As noted above, outer ring 12 is adapted to connect to connecting ring 14 (FIG. 6) and has an inner perimeter surface 32 (FIG. 7) with an annular internal lip 34 (FIG. 8), which provides a snap fit coupling with connecting ring 14. As best seen in FIGS. 10-12, connecting ring 14 is a substantially cylindrical member made from a generally rigid material, such as a metal or a polymeric material, including for example, aluminum or plastic, with an outer perimeter surface 36 (FIG. 11), which corresponds to inner perimeter surface 32 of ring 12 and allows outer ring 12 to slide over connecting ring 14. Referring again to FIG. 11, ring 14 includes an outer face 40 and an external lip 38 located adjacent to outer face 40 along the circumference of outer perimeter surface 36, which cooperates with internal lip 34 (FIG. 8) of outer ring 12 to retain outer ring 12 on ring 14 and provides the snap fit coupling with connecting ring 14 (FIG. 5). Further, friction between inner perimeter surface 32 and outer perimeter surface 36 prevents rotation between outer ring 12 and connecting ring 14.

In order to generate the periods of high and low resistance, in the illustrated embodiment, ring 14 includes a detent mechanism 55 (FIGS. 3 and 3a) that engages an undulating or sinusoidal surface 56 on base 16 (discussed in detail below). Such detent mechanism may be, for example, a ball and spring detent mechanism or an elastomeric member or the like. In the illustrated embodiment, detent mechanism 55 includes a ball 55a, a spring 55b, and a set screw 55c (FIG. 3a). The spring 55b is held in place by set screw 55c and biases the ball toward the base 16 (as discussed in detail below). As the set screw is tightened, the biasing force of the spring 55b increases. Although one detent mechanism 55 is shown, it should be understood that more than one detent mechanism, such as two detent mechanisms, may be used. Detent mechanism 55 extends through an aperture 46 provided in a side wall 48 of connecting ring 14 so that it can then engage base 16.

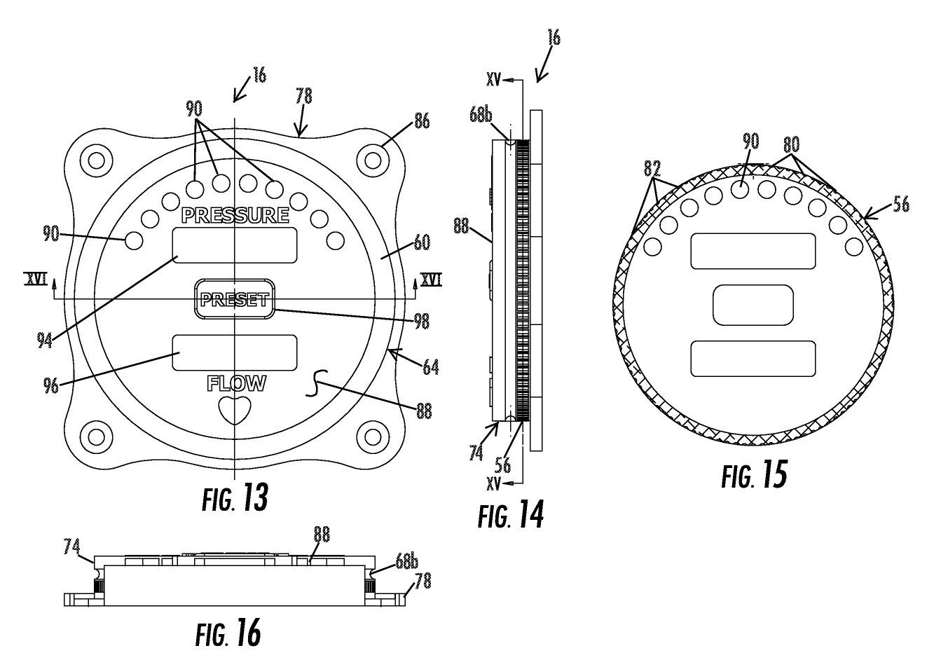

As best seen in FIGS. 5 and 5a, connecting ring 14 includes flange 58 that is adapted to register with a groove 60 formed in base 16. Further, formed between ring 14 and base 16 is a bearing raceway 70 which contains bearings 76 to facilitate rotation between connecting ring 14 and base 16, thereby allowing connecting ring 14 to act as a thrust bearing. In the illustrated embodiment, raceway 70 is formed by an internal annular groove 68a (FIG. 6) formed on an inner perimeter 68 of ring 14 and an external annular groove 68b (FIGS. 6 and 16) formed on the outer surface of annular wall 74 of base 16 (FIG. 14). Thus, when ring 14 is positioned on base 16, grooves 68a and 68b are substantially aligned to form annular raceway 70 (FIG. 5a).

As best seen in FIGS. 13-16, base 16 also includes a mounting flange 78 from which annular wall 74 projects. Undulating profile 56 is formed on annular wall 74 and is optionally provided around the full circumference of wall 74. Undulating profile 56 forms a plurality of peaks 80 and valleys 82 around annular wall 74 for engagement by detent mechanism 55. For example, peaks 80 and valleys 82 may form a sinusoidal surface or profile. Further, peaks 80 and valleys 82 may have a radius of curvature of about 0.032 inches. It will be apparent to the skilled artisan, however, that peaks 80 and valleys 82 may take other forms and have other dimensions without departing from the principles of the present invention.

Thus, when connecting ring 14 is assembled onto base 16, grooves 68a and 68b will be aligned to form the raceway and detent mechanism 55 will be aligned with undulating profile 56. After the connecting ring 14 is mounted onto base 16, bearings 76 are installed in the bearing race formed by annular grooves 68a, 68b through an aperture 44 (FIGS. 6 and 12) formed in side wall 48 of ring 14. A cap 84 is then placed in aperture 44 to retain bearings 76 (FIG. 6) in raceway 70. Once bearings 76 are located in raceway 70 bearings 76 will retain ring 14 on base 16. Further, ball 55a of detent mechanism 55 will be aligned and biased toward undulating profile 56.

Accordingly, detent mechanism 55 seats in one of the valleys (82) and remains seated until outer ring 12 is rotated. When a user rotates outer ring 12, peaks 80 of corrugated profile 56 urge ball 55a towards connecting ring 14 against the spring force of the spring, thereby providing resistance that can be felt by the user. After traversing peaks 80, detent mechanism 55 seats in the next adjacent valley 82. Thus, as a user rotates outer ring 12, the detent mechanism cooperate with peaks 80 and valleys 82 of undulating profile 56 to provide ratchet-like tactile feedback. The tactile feedback can be adjusted by varying the “strength” or biasing force of the spring 55b or the depth of the valleys. As would be understood, by providing a spring 55b with greater spring force, the more affirmative the “clicks” are as outer ring 14 is rotated, while springs with weaker biasing forces generate less noticeable “clicks” as outer ring 14 is rotated.

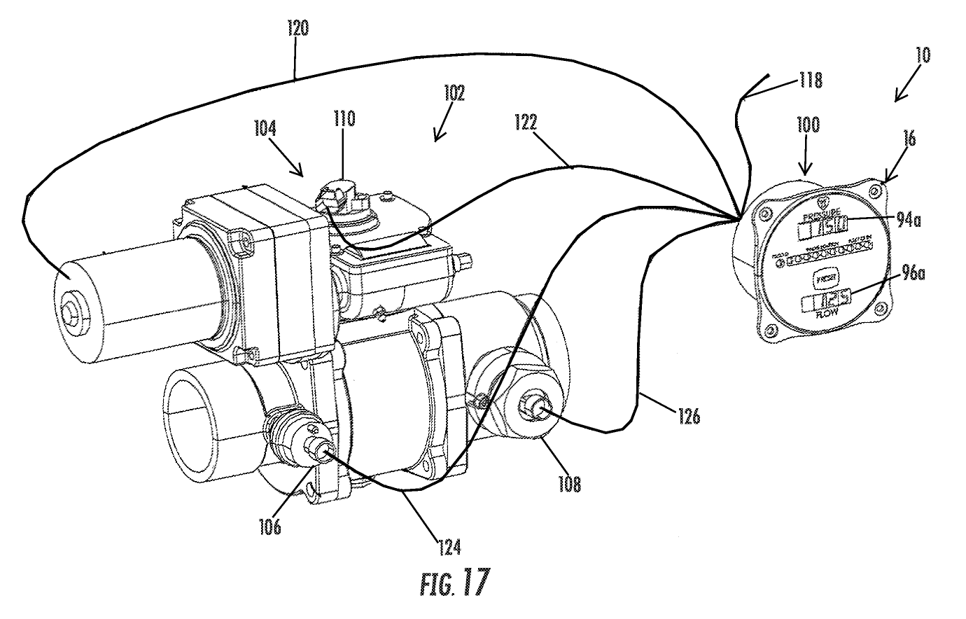

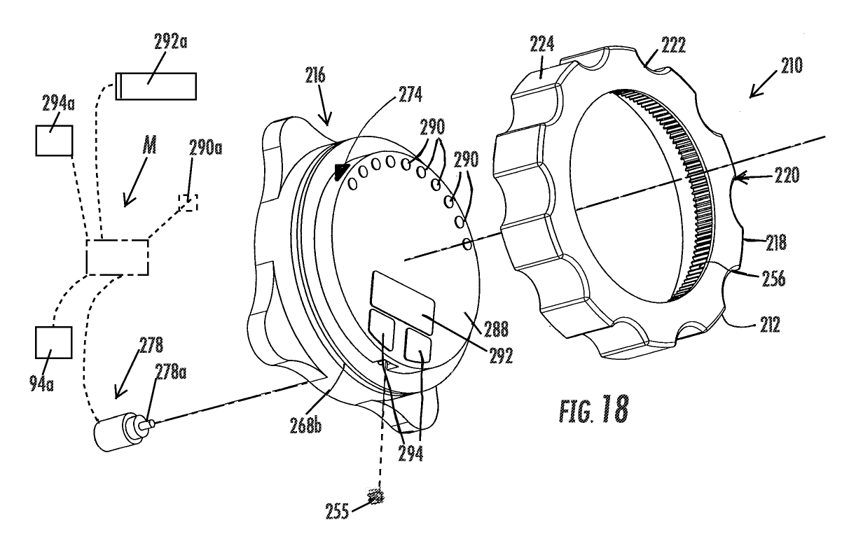

Referring now to FIGS. 13-16, mounting flange 78 of base 16 has one or more mounting apertures 86 for mounting rotary control 10 to a panel or other planar surface. Base 16 may also have an outer face 88 with one or more openings 94 and 96 with displays (94a and 96a, FIG. 17) positioned therein, such as LCD displays. Outer face 88 may include another set of openings 90 (FIG. 16) in which lights are located, such as light emitting diodes (LEDs). For example, openings 90 may be arranged along an arcuate path to provide a visual indicator of the state of an electromechanical device, such as the position of a ball or gate of a valve, for example, (as described in detail below). For example, as outer ring 12 is rotated clockwise, the LEDs may be configured to illuminate successively starting with a first LED to the left and continuing with successive adjacent LEDs in a clockwise direction along the arcuate path, or vice-versa. In this manner, the LEDs may indicate the relative position of ring 12, which forms a knob or dial. As noted, outer face 88 may also include displays, such as liquid crystal displays (LCDs). Such LCDs may include a pressure display and a flow display, such as fluid pressure and fluid flow in a firefighting apparatus. Outer face 88 may yet further include a button, such as a preset button 98 for setting a microprocessor-based control (see item M in reference to the second embodiment) to a preset condition (FIG. 17).

Referring again to FIG. 5a, rotary control 10 may include control circuitry located in or adjacent base 16. In order to convert the rotary motion of ring 12 (and ring 14) into signals, inwardly facing side 14b of ring 14 includes a plurality of projections 14c (FIGS. 5a and 10), such as magnetic or steel bumps 14c, which align with an inductive strip 16a positioned in base 16. The bumps 14c are arranged in pairs around the circumference of ring 14 and create high and low points of capacitance when they pass by the inductive strip 16a. These high and low points of capacitance are used as counters to determine how far the ring has been rotated (but see the discussion of high speed rotation of ring 12 noted below). Further, in order to indicate the direction of rotation of ring 12, each pair of bumps has one bump with a first height and a second bump with a second height that is lower or higher than the first height. In this manner, the microprocessor-based control can use the different signals generated by two different size bumps to determine which way the ring is being rotated.

Base 16 optionally includes a housing 100 (FIG. 17), which houses the microprocessor-based control (see M in reference to the second embodiment), which is in communication with the induction strip 16a and, as noted, is adapted to determine the direction of the rotation of rings 12 and 14 and the position of the rings (12 and 14) relative to base in response to the signals generated by the projections on ring 14 as they pass strip 16a. While the illustrated embodiment of control 10 uses an inductive sensor to determine the position and speed of rings 12 and 14, other sensors may be used, such as optical sensors, magnetic hall sensors, or the like. Further, base 16 may incorporate a slip clutch or the microprocessor-based controller may be configured so that if rings 12 and 14 are moved too quickly, the signals will be limited. For example, if rotary control is used to move a valve ball or other device, the movement of the valve ball will be limited to a maximum speed (for example, as stored in the microprocessor-based controller) and no longer directly proportional to the speed of the ring.

Referring now to FIG. 17, as noted above, base 16 of control 10 may include a housing 100, which may in turn house the microprocessor-based control and other control circuitry, for example, for the displays, LED's and buttons. In the illustrated embodiment, control 10 is used to control a valve 102 for firefighting and fluid control operations. In the illustrated embodiment, control 10 is configured to control the actuator 104, for example a motor and associated gearing, that opens and closes valve 102. As best seen in FIG. 17, control 10 connects to a power source via power line 118, and is communication with actuator 104, a pressure sensor 106, a flow sensor 108 and a valve position sensor 110 via power line 120, pressure feedback line 124, flow feedback line 126, and position feedback line 122, respectively. Therefore, control 10 receives power from power line 118 and sends power, such as 12 VDC power, to actuator 104 to thereby move the valve ball or gate. Pressure sensor 106 and flow sensor 108 then send pressure and flow data signals interpreted by the microprocessor-based control, which are then displayed on display 94a and display 96a, respectively.

As would be understood, rotating outer ring 12 causes actuator 104 to open or close valve 102, in response to the position of ring 12 relative to base 16. Valve position sensor 110 then sends a signal to control 10, illuminating LEDs according to the relative position of valve ball, e.g. none of the LEDs are illuminated when valve 102 is fully closed, and all of LEDs are illuminated when valve 102 is fully open. However, valve 102 (and, hence, LEDs 90a) may not be directly coupled to the rotation of outer ring 12. For example, as noted above, a given amount of rotation of outer ring 12 performed rapidly may result in less adjustment of valve 102 than the same amount of rotation performed slowly. Thus, the maximum rate of adjustment of valve may be limited. In the illustrated embodiment, such limitation is accomplished by signal processing within the microprocessor-based control, but may also be accomplished mechanically. For example, as described above, a slip clutch or the like may be placed between outer ring 12 and connecting ring 14, or between connecting ring 14 and base 16.

Although illustrated as controlling a valve, it will be apparent to one skilled in the art that rotary control 10 can be used to control other electromechanical devices, such as firefighting monitors, engines, pumps, lights, and the like. For example, a suitable method of controlling the throttling of an engine, reference is made herein to U.S. Pat. No. 6,772,732, which is herein incorporated by reference in its entirety.

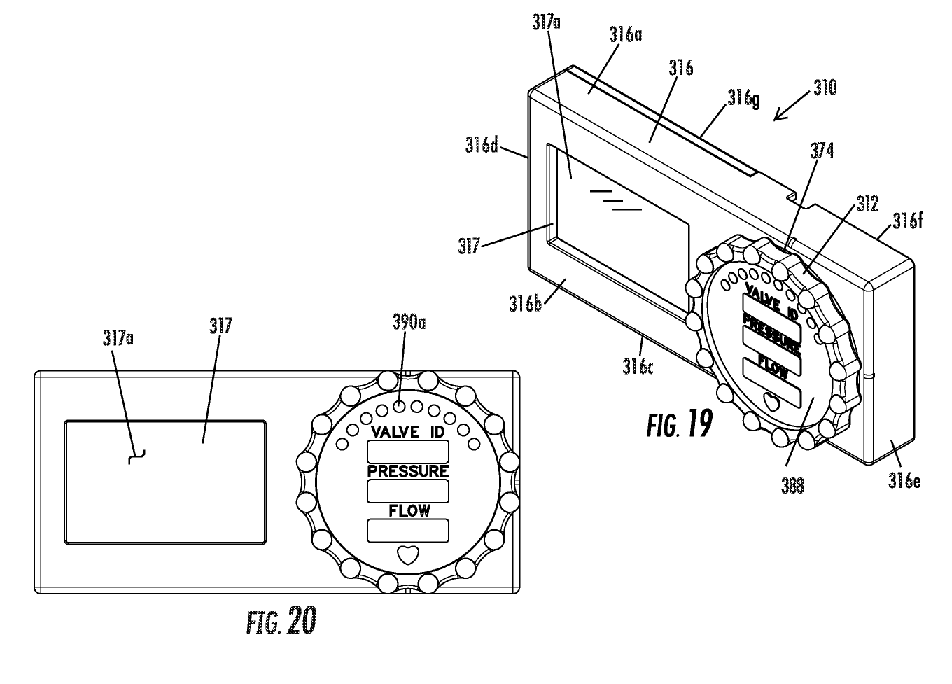

Referring to FIG. 18, the numeral 210 generally designates another embodiment of the rotary surface mount control of the present invention. Similar to the previous embodiment, control 210 includes a base 216 and an outer ring 212 rotatably mounted to base 216. Ring 212 includes an outer perimeter 218 with an undulating profile 220 formed by a plurality of indentations 222 that project radially inward into ring 212 thereby forming between each of the recesses projections 224 which facilitate manipulation by a gloved hand.

Ring 212 comprises an annular member or body, which mounts to upstanding annular wall 274 of base 216 and includes at its inner perimeter a plurality of spaced ridges or tines. Tines 256 are engaged by a gear 255 mounted in base 216 and positioned in an opening in annular but which is partially extended from annular wall 274 of base 216 to engage the tines. Gear 255 is coupled to an encoder 278 positioned in base 216, which includes a shaft 278a that projects from the encoder and on which gear 255 may be mounted. In this manner, as ring 212 rotates about base 216, gear 255 is driven to thereby generate position signals via the encoder, which are transmitted to microprocessor M so that the device being controlled by control 210 may be operated in accordance with the position signals received by microprocessor M.

Similar to the previous embodiment, base 216 includes an outer face 288, which includes a plurality of openings 290, 292, and 294 for positioning LEDs 290a and display screens 292a and 294a, each of which are in communication with microprocessor M. For further details of the operation of the lights, namely LEDs 290a and displays 292a and 294a, reference is made to the previous embodiment. Also provided at an inner perimeter of ring 212 is a groove (not shown), which cooperates with a corresponding groove 268b formed in annular wall 274 to thereby form a raceway for receiving ball bearings to thereby retain annular ring 212 on base 216 and, further, to facilitate rotation of annular ring 212 about base 216, similar to the previous embodiment.

Although not illustrated, similar to the previous embodiment, control 210 may be adapted to provide a tactile and/or audible feedback to the user of the control when adjusting the control. Further, although illustrated with a single ring that forms the knob or dial and provides the interaction with the base, it should be understood that ring 212 may incorporate a separate connecting ring similar to ring 14.

Referring to FIGS. 19 and 20, the numeral 310 generally designates yet another embodiment of the surface mount rotary control of the present invention. Control 310 includes a ring 312 and an optional intermediate connecting ring (not shown), which mounts ring 312 to base 316, which in the illustrated embodiment is configured as a handheld device housing. Housing 316 is formed with a generally upstanding annular wall 374 on which ring 312 is mounted in a similar manner to the first embodiment. Therefore, for further details of annular ring 312 and its mounting arrangement and, further, the devices that may be mounted to outer facing surface 388 of base 316, reference is made to the first embodiment.

In the illustrated embodiment, housing 316 is configured as a rectangular enclosure with an upper housing wall 316a, a front facing housing wall 316b, a lower facing housing wall 316c, end walls 316d and 316e, and a back housing wall 316f, which define a compartment for holding the microprocessor based control and associate circuitry. Back wall 316f may be removable or include a removable panel 316g to allow access to the components within base or housing 316. Further, forward facing side 316b may include an opening 317 to receive a screen 317a, such as an LCD screen or the like, including a touch screen. For example, screen 317a may be configured to display icons, such as described in copending application entitled FIREFIGHTING DEVICE FEEDBACK CONTROL, U.S. Ser. No. 12/174,866, filed Jul. 17, 2008 (Attorney Docket No. ELK01 P-326A), which is herein incorporated by reference in its entirety. In this manner, in addition to being able to determine the relative position of the valve gate or ball, for example, using the LED's 390a, which delivers fluid to, for example a monitor, the orientation of the monitor may be monitored using screen 317a. Optionally, handheld device 310 may be coupled using wiring or cabling or may include an antenna to allow radio frequency transmission between control 310 and the device being controlled and/or monitored.

Changes and modifications to the specifically described embodiments may be carried out without departing from the principles of the present invention, which is intended to be limited only by the scope of the appended claims as interpreted according to the principles of patent law.

The embodiments of the invention in which an exclusive property is claimed are defined as follows:

1. A rotary control for controlling an electromechanical device, said control comprising:
a base, said base have a base outer face;
an annular member rotatably mounted to said base about said base outer face, said annular member having an outer perimeter with an undulating profile forming peaks and valleys, and said annular member further defining an annular member outer face with a plurality of protrusions extending therefrom, wherein said protrusions substantially correspond with said peaks to thereby formed a gripping surface that projects outwardly from said base outer face and said annular member outer face;
a sensor adapted to sense rotation of said annular member and output a signal corresponding the rotation; and
a control adapted to receive said signal and control the electromechanical device as a function of the rotation of said annular member.

2. The rotary control according to claim 1, wherein said annular member comprises an outer annular member and an inner annular member, said inner annular member mounting said outer annular member to said base.

3. The rotary control according to claim 1, wherein said annular member is adapted to a provide tactile feedback or audible feedback or visual feedback when said annular member is rotated about said base.

4. The rotary control according to claim 1, wherein said annular member is adapted to encounter fixed periods of high resistance and low resistance to rotation about said base.

5. The rotary control according to claim 4, wherein said fixed periods of high resistance and low resistance are generated by a detent mechanism.

6. The rotary control according to claim 5, wherein one of said base and said annular member includes an undulating surface and the other of said base and said annular member supports said detent mechanism, said detent mechanism generating said feedback in response to traversing said undulating surface.

7. The rotary control according to claim 6, wherein said detent mechanism comprises a ball and spring, said spring urging said ball into said undulating surface.

8. The rotary control according to claim 1, wherein said sensor comprises an inductive sensor.

9. The rotary control according to claim 1, wherein said base comprises a housing, said control stored in said housing.

10. The rotary control according to claim 9, wherein said housing forms a hand-held device.

11. The rotary control according to claim 10, wherein said housing supports a display.

12. A rotary control for controlling an electromechanical device, said control comprising:
a base having a cylindrical wall, said cylindrical wall having an outer periphery with an external annular groove and an undulating surface;
an annular member having an inner perimeter, said annular member being rotatably mounted on said base with said inner perimeter adjacent to said cylindrical wall, and said annular member supporting a detent mechanism, said detent mechanism engaging said undulating surface, and said undulating surface and said detent mechanism generating regions of high resistance and lower resistance when said annular member is rotated about said base; and
an outer surface supported or formed by said annular member, said outer surface having an undulating profile forming recesses and protections, said recesses and projections being spaced to accommodate gloved fingers wherein said control may be operated by a user wearing gloves; and
a sensor adapted to sense rotation of said outer ring and output a signal corresponding to the rotation.

13. The rotary control according to claim 12, wherein said annular member comprises an inner annular member and an outer annular member, said outer surface is formed by said outer annular member, and said outer annular member rotatably coupled to said inner annular member.

14. The rotary control according to claim 13, wherein said outer annular member is rotatably coupled to said inner annular member by friction.

15. The rotary control according to claim 13, wherein said outer annular member is rotatably coupled to said inner annular member by a snap fit coupling.

16. The rotary control according to claim 12, further comprising a microprocessor-based control, said microprocessor-based control adapted to receive said signals from said sensor and control the electromechanical device as a function of the rotation of said outer ring.

17. The rotary control according to claim 16, wherein said microprocessor-based control has stored therein a maximum speed associated with controlling the electromechanical device, when the rotation of said outer annular member exceeds the maximum speed, said microprocessor-based control controlling the electromechanical device based on said maximum speed rather than the rotational speed of the outer annular member.

18. The rotary control according to claim 12, wherein said base forms a hand-held device housing.

19. The rotary control according to claim 18, wherein said hand-held device housing includes a display.

20. The rotary control according to claim 19, wherein said hand-held device housing includes a cylindrical wall with an outer face, said annular member rotatably mounted to said base about said outer face, and said outer face including said display.

21. The rotary control according to claim 12, in combination with an electromagnetic device.

22. The rotary control according to claim 22, wherein said electromagnetic device comprises an engine governor.
